(19) United States
(12) Patent Application Publication
(10) Pub. No.: US 2007/0055679 A1
(43) Pub. Date: Mar. 8, 2007

(54) Data expansion method and data processing method for structured documents

(75) Inventors: Shigeru Yoshida, Kawasaki (JP); Satoshi Nakashima, Kawasaki (JP); Junichi Odagiri, Kawasaki (JP); Takuroh Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/334,525

(22) Filed: Jan. 19, 2006

(30) Foreign Application Priority Data
Aug. 25, 2005 (JP) 2005-243703

(51) Int. Cl. G06F 7/00; G06F 17/00; G06F 9/45

(52) U.S. Cl. 707/100; 717/144; 715/513

(57) ABSTRACT

A structured document expansion method converted a structured document into a format enabling easy manipulation by an application. A structured document is expanded into a format for easy manipulation without requiring complex knowledge. A two-stage associative array structure is adopted to enable easy manipulation of various types of data spanning the entire structured document merely through intuitive array operations, and both associative arrays are linked by sequence numbers. The latter-stage associative array can be accessed from the former-stage associative array using element names, and in addition, the latter stage can be made a two-dimensional associative array to represent hierarchical levels.

### CROSS-REFERENCE TO RELATED APPLICATIONS

This application is based upon and claims the benefit of priority from the prior Japanese Patent Application No. 2005-243703, filed on Aug. 25, 2005, the entire contents of which are incorporated herein by reference.

### BACKGROUND OF THE INVENTION

1. Field of the Invention

This invention relates to a data expansion method and data processing method for structured documents written in XML (eXtensible Markup Language) or similar, and more particularly relates to a data expansion method and data processing method for structured documents to facilitate the development and utilization of XML applications using XML documents.

2. Description of the Related Art

In recent years, individuals, corporations, municipalities, and all manner of other entities have been connected via the Internet, and cooperation among these entities has led to Web services, EDI (Electronic Data Interchange), and EC (Electronic Commerce). Consequently a wide variety of information exchange has become necessary; and because of its flexible expressive power in structuring data for data exchange and data processing, XML (eXtensible Markup Language) has attracted attention as a common-foundation format suited to computer processing.

XML is based on the SGML (Standard Generalized Markup Language) standardized by the ISO in 1986, and in February 1998, the basic XML 1.0 specification was formulated by the W3C (World Wide Web Consortium) in order to facilitate utilization on the Internet.

The Web page creation language HTML (Hyper Text Markup Language) has fixed tags and specializes in display, and there is the problem that HTML cannot accommodate demands for information processing by a computer based on tag information. XML has a language structure enabling a user to freely define tags and assign meanings to character strings in a document, and can be used for information processing on a computer.

Here terminology is defined based on the XML standard. A character string surrounded by a pair of “<-->” is called a tag, “<character string>” is a start tag, “</character string>” is an end tag, the entire character string from a start tag to an end tag inclusive is an element, the character string enclosed between the start tag and the end tag is the element content, the name of the element described within a tag is the element name (or tag name), and information appended to an element is called an attribute.

Such a structured document can describe a data structure, in the form of tags embedded within the document itself. By adopting a configuration in which a data structure is described by tags embedded in a document, flexibility and expandability with respect to the addition, deletion, and modification of data items are obtained. And by assigning, as tag names, names which humans can read and understand, the data can be made readable.

When performing searches, updating, deleting, or other operations on such XML documents, the XML document must be expanded into a data format for easier processing for the application software. As shown in FIG. 9, infrastructure software (structured document expansion software) 110, which is API (Application Programming Interface) software, reads an XML document file 100 and expands the data into a standard format in memory. This expanded document is searched and updated by the user employing data search and update application software 112. The infrastructure software 110 writes the searched and updated document to an XML document file 102.

In an XML document which is a representative structured document, in order that the application software can handle the XML document, two API (Application Programming Interface) standards have been adopted, called DOM (Document Object Model) and SAX (Simple API for XML).

An XML API software package is called a Parser. When using different XML parsers to develop various applications, the same API can be used to manipulate XML data, so that the efficiency of development is improved and XML programming know-how can be accumulated.

Of the two APIs, SAX has such features as requiring little memory consumption and generally being fast, but providing time-series output and being suited to simple processing involving referencing only. On the other hand, DOM features include generally slow speeds and large memory consumption, but with expansion of document elements into hierarchical trees, so that programming is easy even for complex processing content. Consequently DOM is often used in XML data processing attended by data updates and random access.

FIG. 10 explains XML documents, and FIG. 11 and FIG. 12 explain DOM as a technology of the first prior art. The XML document of FIG. 10 is an example of a product catalog; the character string enclosed between the start tag <catalog> and the end tag </catalog> indicates the catalog contents (element contents), within which the character string (MS360) enclosed between the start tag <model name> and the end tag </model name> is the model name element content, and the character strings enclosed between the start tag <part type= . . . > and the end tag </part> are the part elements and element contents.

As shown in FIG. 11, when an XML parser recognizes an element in XML data, in the case of the DOM API a DOM tree is generated based on the element. That is, the processor reads the XML data all at once, performs syntactic analysis, and expands the data into a tree in memory (this tree is called a “DOM tree”). In the DOM API, a DOM tree expanded in memory in this way can be accessed, and elements added and deleted, to update the structure of the XML data. The DOM API defines an interface enabling random access of each element in this tree.

A DOM tree object has the same structure regardless of the programming language and OS, and so application development independent of the programming language or platform is possible. In particular, random access of a tree is possible, so that the DOM API is advantageous when there is a need to make major changes to an XML tree structure.

DOM uses objects to model XML data. Just as in object-oriented technology an object comprises properties and methods, so a DOM object comprises “attributes” (data and related information held by the object) and “methods” (functions controlling the behavior of the object).

DOM has two perspectives: (a) documents, elements, and other objects as interfaces seen as XML structural elements, and (b) node objects as interfaces seen in terms of the tree structure. Hence an object representing an XML element is an element, and in addition is a node.

When accessing a DOM tree, a node object alone is used to enable a degree of manipulation of the tree; for example, in the case of the XML document for part list shown in FIG. 10, the document is expanded in memory as a DOM tree by the DOM parser, as shown in FIG. 11.

Viewing object types in FIG. 11, “catalog” is a document element type, name “part” is a node list type, name “name, “model number”, name “clock”, name “cache”, and name “notes” are also the nodelist type, name “option” is the node type, and name “type” is a named node map type.

Each type has different methods (object behavior). For example, the nodelist type has, as methods “get Element by Tag Names”, “first Child”, and “next Sibling”; the node type has the methods “has ChildNodes”, “childNodes”, “nodeName”, and similar.

In data update processing using the DOM API, as shown in FIG. 12, after reading the XML document, the document is expanded into a DOM tree in memory, as in FIG. 11. The root element of the DOM tree is acquired, a record element is acquired as a child element, and the sibling relations of nodes are traced back to access (search for) a desired element object. Then, using a corresponding method, the element name and element contents are overwritten, and the XML document is written to output (see for example Japanese Patent Laid-open No. 2003-67403).

In this way, the DOM API has the advantages of enabling record insertion and deletion, element name modification, modification of data structures within records, and other manipulation of any of the data present; however, programming is complex, and element accessing requires tracing parent-child and sibling relations.

FIG. 13 through FIG. 15 explain a technology of the second prior art, illustrating a method which uses an associative array. This method is adopted separately for individual programs using a script language when handling XML, and does not involve API software. After DOM expansion of an XML document as described above, record portions are acquired, and element contents are stored and handled in an associative array indicating the indices with the element names. Here, an array of the indices which are character strings is called an “associative array”.

For example, in the case of the parts catalog of the above-described FIG. 10, a record portion (CPU kit, or similar) is extracted and is stored in the associative arrays Array[1], [2], as in FIG. 14. As shown in the storage and specification method of FIG. 13, one dimension index arrays Array[1], [2] specifies the record number, and two dimension index [“name”] specifies the element content (CPU kit, or similar) of the associative array specified by the element name in the record. The address in the associative array is specified by the record number of the one (first) dimension index (the numbers “1”, “2”), and the element name by the two (second) dimension index, and using these the stored element contents can be retrieved and written (see, for example, National Publication of Translated Version No. 2002-517823).

That is, as shown in the flow of processing in FIG. 15, the XML document is read, and after the above-described DOM expansion the record portion of interest is extracted, and the element contents are stored in the associative array with the element name as the index. Then, the one dimension index record numbers (numbers “1”, “2”), and the element names of the two dimension index, are used to specify the address in the associative array, and the stored element contents are accessed and updated. Here, the element name is a simple index and so cannot be modified.

The first dimension index record numbers (numbers “1”, “2”) and the second-dimension indices are counted, and the stored contents are output. Here, if an associative array alone were used, it would not be possible to restore the original XML document, and so by placing the output in the portion from which the data was retrieved in the original XML document, the result is output (displayed, printed) as an XML document.

An advantage of this associative array method is that programming after the associative array storage is simple. That is, parent-child relations and sibling relations are eliminated, so that application software can be developed without taking these relations into account.

The DOM (Document Object Model) API, which is a representative API of the prior art, uses a list format to handle all of the parent-child and sibling relations in the hierarchical structure of an XML document, and has the advantage of enabling general use no matter how complex the XML document. However, there are the problems that specialized knowledge of this XML standard API (knowledge of the type of each object, and of type methods) is necessary, and that programming is difficult.

That is, in application software an XML document is manipulated via the API software (infrastructure software), and so consequently SE (system engineer) programming to create an XML application program is difficult.

On the other hand, in the associative array method of the prior art, an array is used, so that there is the advantage that referencing and updating are easy. However, the indices of the associative array are fixed during use, and element names cannot be modified. And, there is no order to the elements of a specified portion (record), so that upon output the user must specify the order. Further, during write-back, because there is no order among the elements in a record stored in the associative array, if the user does not specify the order, write-back is not possible.

### SUMMARY OF THE INVENTION

An object of this invention is to provide an expansion method and processing method for structured documents, to facilitate the development of application software for structured documents expressing element names and element contents.

Another object of this invention is to provide an expansion method and processing method for structured documents, which can be used as an application programming interface for structured documents expressing element names and element contents.

Still another object of this invention is to provide an expansion method and processing method for structured documents, to easily execute modification of the hierarchy within a record, modification of element names, and record insertion and deletion, in structured documents expressing element names and element contents.

In order to attain the above object, a structured document expansion method of this invention is a structured document expansion method of dividing into elements a structured document comprising records, and expanding the structured document into memory. The structured document expansion method has a step of assigning and storing the elements in a first-stage associative array, with an element name/attribute name including the path as an index and with a sequence number related to the order of appearance assigned to the contents, and a step of storing element contents/attribute values corresponding to the contents in a second-stage associative array, with the sequence numbers as an index.

Further, a structured document processing method of this invention is a structured document processing method of dividing into elements a structured document having records, expanding the structured document into memory, and processing the expanded records. The structured document processing method has a step of assigning and storing the elements in a first-stage associative array, with an element name/attribute name including the path as an index and with a sequence number related to the order of appearance assigned to the contents; a step of storing element contents/attribute values corresponding to the contents in a second-stage associative array, with the sequence numbers as an index; a step of using the sequence number to process the element contents/attribute values of a record specified by the element name/attribute value including the path; and a step of reading the element contents/attribute values using the sequence number, and writing out the structured document.

In this invention, it is preferable that the step of assigning sequence numbers and storing has a step of assigning a first sequence number as a first-dimension index and storing the higher hierarchical level of the record element, and a step of assigning and storing a second sequence number as a second-dimension index and storing the level within the record element.

In this invention, it is preferable that the step of assigning the first sequence number and storing have a step, when a level outside a specified record is represented, of assigning the first sequence number with an interval provided.

Further, in this invention it is preferable that the structured document be an XML document.

Further, in this invention it is preferable that the processing method further have a step of reading and converting the XML document into event type output with element start tags, element contents, and element end tags, and of inputting the converted event as the element.

Further, in this invention it is preferable that the step of assigning sequence numbers and storing further have a step of detecting start tags in record elements of the XML document, a step, upon detection of a start tag, of assigning a first sequence number and storing the element name of the record element, and a step of assigning a second sequence number and storing the element name of the record element in succession to the record element of the start tag. And the step of storing the element contents/attribute values has a step of storing the element contents of the record element at the position corresponding to the second sequence number.

Further, in this invention it is preferable that the step of assigning the first sequence number and storing have a step, when representing a level outside a specified record, of assigning the first sequence number with an interval provided.

Further, in this invention it is preferable that the step of assigning the sequence numbers and storing have a step of detecting a start tag in the higher level of a record element in the XML document, a step, upon detecting the start tag, of assigning a first sequence number and storing the element name of the record element, a step of setting a two-dimensional array at a link destination of the first sequence number, a step of detecting a start tag in the record element, and a step, upon detecting a start tag within the record element, of assigning a second sequence number and storing the element name of the record element. And the step of storing the element contents/attribute values, has a step of storing the element contents of the record element at the position corresponding to the second sequence number in the previously set two-dimensional array.

Further, in this invention it is preferable that the method further have a step of scanning specified record elements to which first sequence numbers have been assigned and searching for the first sequence number of a specified record element, and a step of scanning the element contents within a record element to which the second sequence number corresponding to the two-dimensional array of first sequence numbers has been assigned, and of extracting the element contents in the two-dimensional array.

Further, in this invention it is preferable that the processing step has a step of using the sequence numbers for transfer to an associative array having different element contents/attribute values.

Further, in this invention it is preferable that the processing step has a step of transferring to and association with an associative array having a set of different tag names, which is the structured document, and of manipulating the same XML document using a different vocabulary.

In the prior art, APIs for XML and other structured documents have been general-use APIs capable of handling any XML document, no matter how complex; and to this extent, manipulation has been complicated. In order to resolve this problem, in this invention a method is specialized for record-format XML documents; a record element is specified for the XML document of interest, the element, expanded in memory, is stored in two stages of associative arrays, and merely through intuitive array operations, manipulation of various data spanning the entire XML document can be easily performed. That is, two stages of associative arrays are adopted, with sequence numbers used to link to both associative arrays, and using element names from the associative array of the former stage, the latter-stage associative array can be accessed, while in addition the latter-stage two-dimensional associative array is used to represent the level.

### BRIEF DESCRIPTION OF THE DRAWINGS

FIG. 1 explains processing to expand a structured document using associative arrays in one embodiment of the invention;

FIG. 2 explains the specification method in the program of FIG. 1;

FIG. 3 explains the API in an embodiment of the invention;

FIG. 4 is a diagram of the flow of memory storage processing in an embodiment of the invention;

FIG. 5 is a diagram of the flow of write-out processing in an embodiment of the invention;

FIG. 6 is a diagram of the flow of processing of a structured document in an embodiment of the invention;

FIG. 7 explains processing of a structured document in another embodiment of the invention;

FIG. 8 explains transfer of the associative array of FIG. 7;

FIG. 9 explains a system for processing structured documents of the prior art;

FIG. 10 explains the structured document of FIG. 9;

FIG. 11 explains a structured document API of the prior art;

FIG. 12 is a diagram of the flow of processing in FIG. 11;

FIG. 13 explains associative array processing of structure documents of the prior art;

FIG. 14 explains access processing for associative arrays of structured documents of the prior art; and,

FIG. 15 is a diagram of the flow of associative array processing of structured documents of the prior art.

### DESCRIPTION OF THE PREFERRED EMBODIMENTS

Below, embodiments of the invention are explained, in the order of a structured document expansion method, structured document expansion processing, structured document processing using structured document expansion processing as an API, and other embodiments.

Structured Document Expansion Method

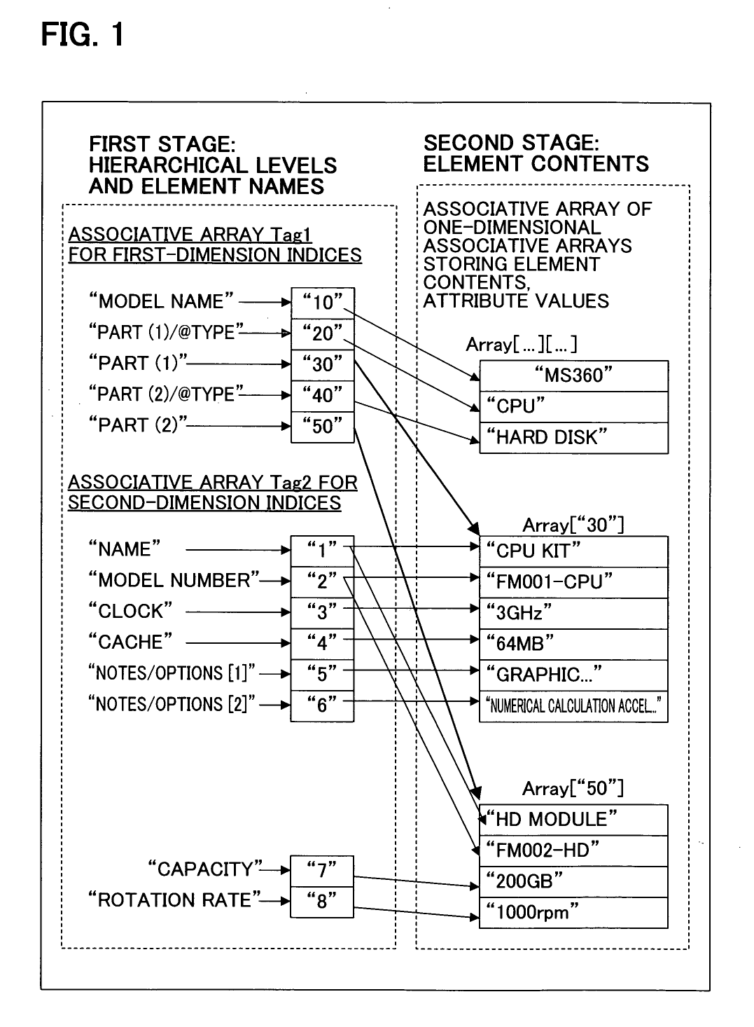

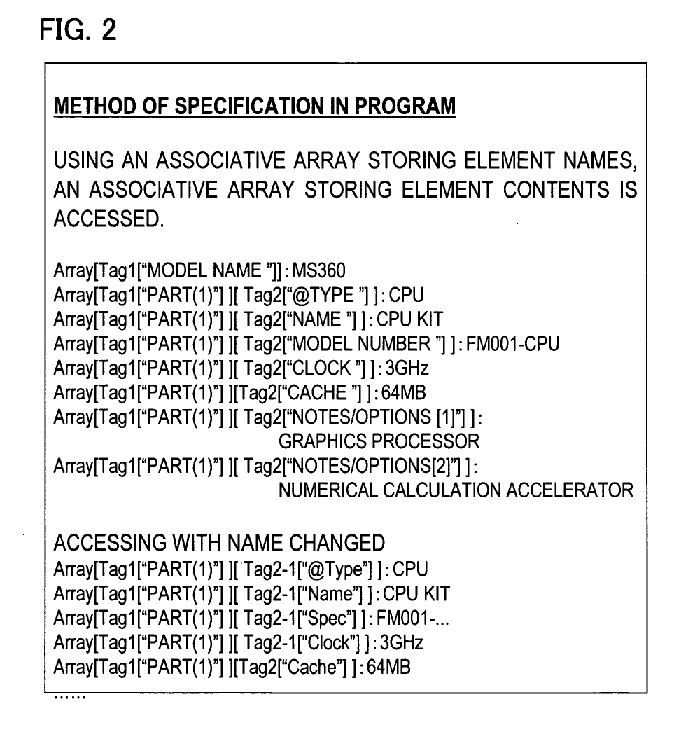

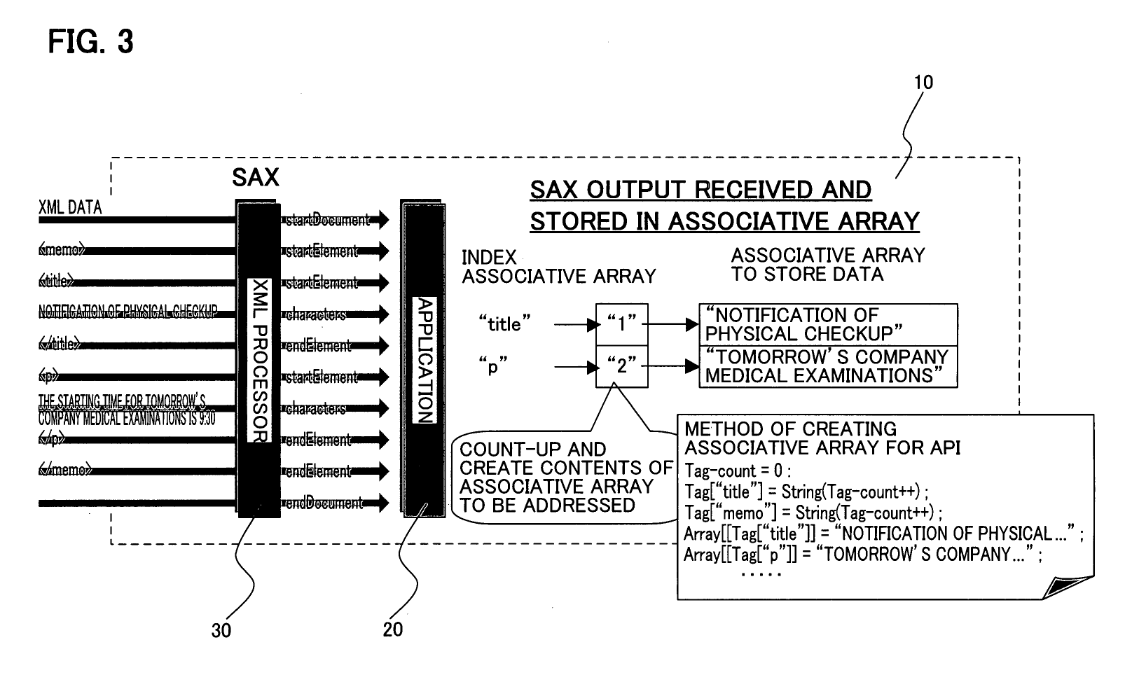

FIG. 1 explains processing to expand a structured document using associative arrays in an embodiment of the invention, FIG. 2 explains the specification method in the program of FIG. 1 for the associative array of tags and the associative array of contents, and FIG. 3 shows deployment in the API of a structured document expansion method of this invention.

As shown in FIG. 1, this invention is based on a two-stage associative array configuration. That is, links from element names containing the XML document path are stored in the first-stage tag associative arrays Tag1, Tag2, and element contents and attribute values are stored, as link destinations, in the second-stage element content and attribute value associative arrays. The links (Tag1, Tag2) of the first-stage associative arrays are sequence numbers. In order to expand the XML document in the format of FIG. 1, the XML document is analyzed using SAX (Simple API for XML), and this link is appended to the stream of element names and element contents output by SAX.

The tag associative arrays Tag1, Tag2 are one-dimensional associative arrays which take element names as indices and provide storage positions; the stored contents of Tag1 and Tag2 indicate the level (paths) and element names for Tag1 and Tag2 taking sequence numbers as links, used to access the stored contents (element contents) of element content and attribute value associated arrays in the second stage. That is, a link with an assigned sequence number is established between the element name including the path, and the element content associated array. Within and outside the record which is the level, the index of the tag associative array Tag1 is represented and is linked with second-stage associative arrays and distinguished. The link Tag2 serves the following purposes.

(1) Provides an order for elements (element names, element contents)

(2) By modifying the numbers of Tag1 and Tag2, facilitates record insertion.

(3) A separate vocabulary can be used to establish links to a plurality of element contents, in an element name associative array, for a single element name. Normally, when DOM processing is used, if handled using a separate name all data is converted by using XSLT before being handled; this conversion becomes unnecessary.

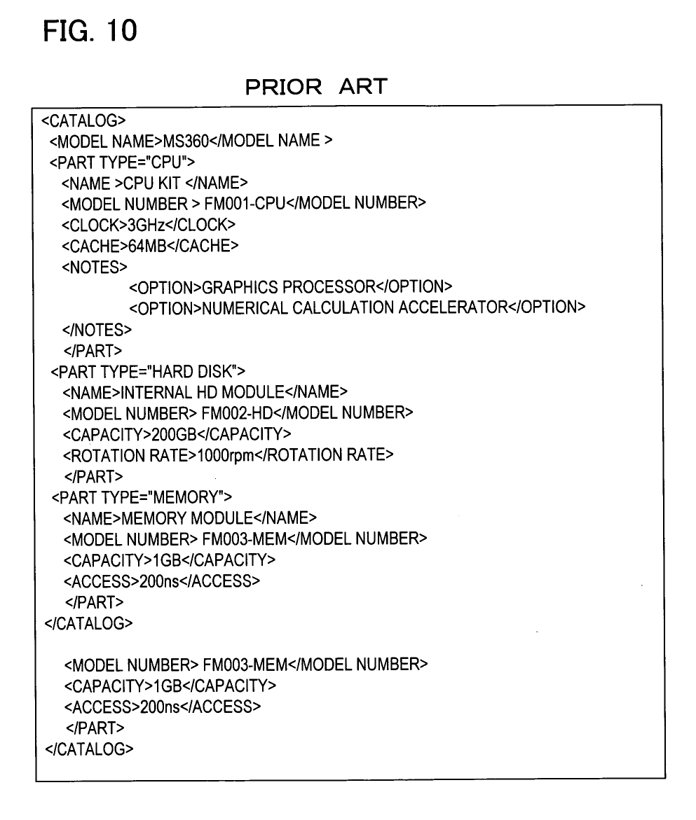

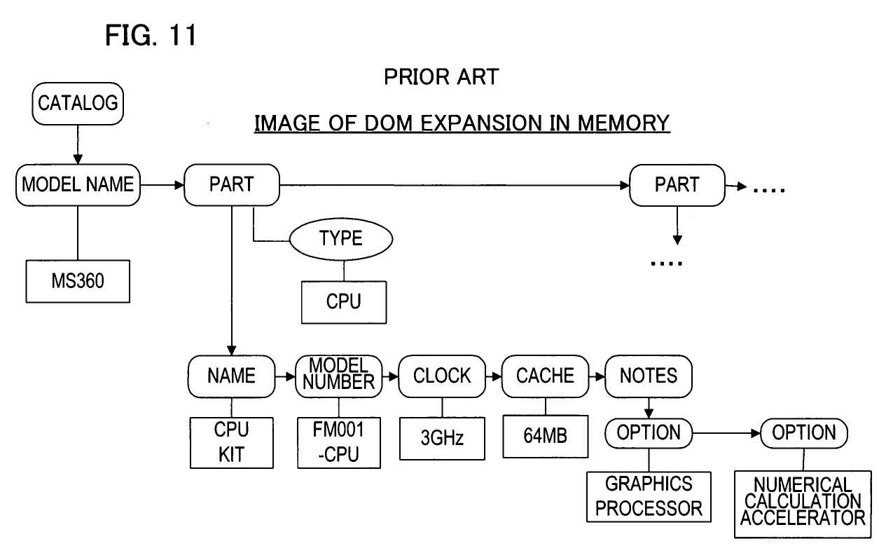

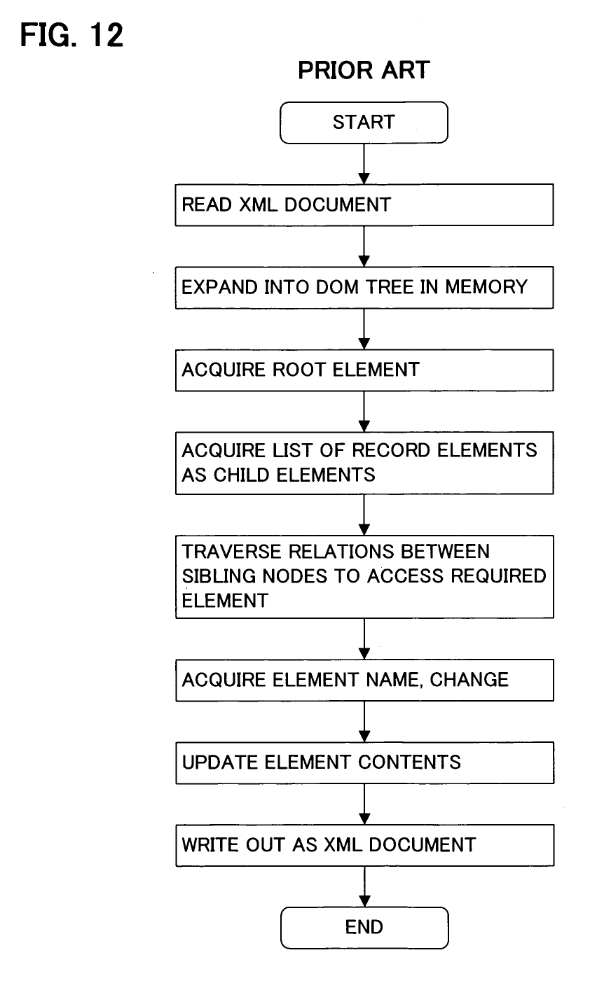

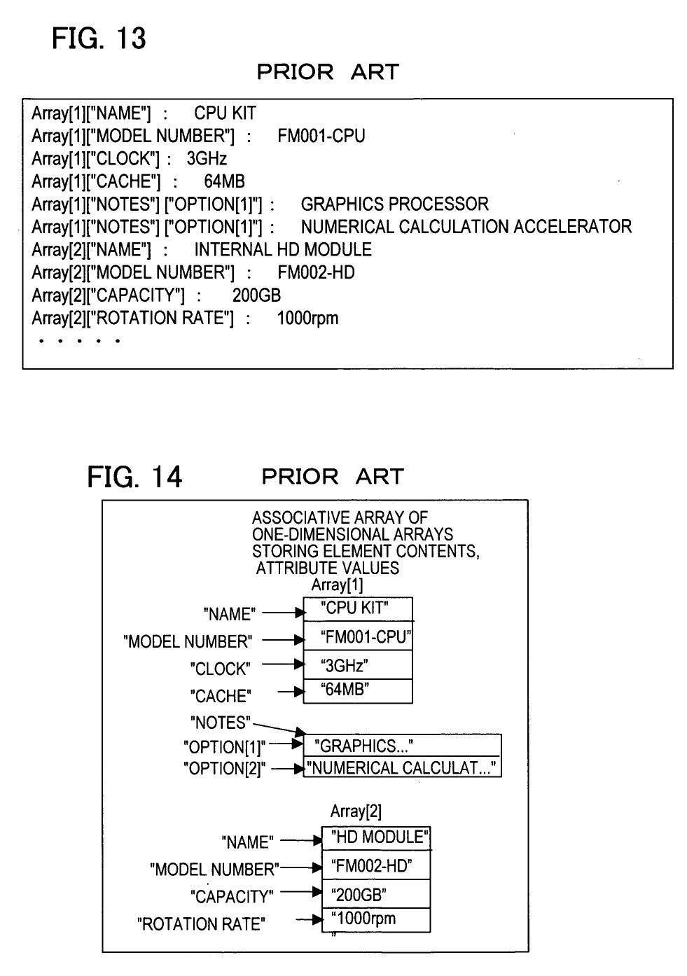

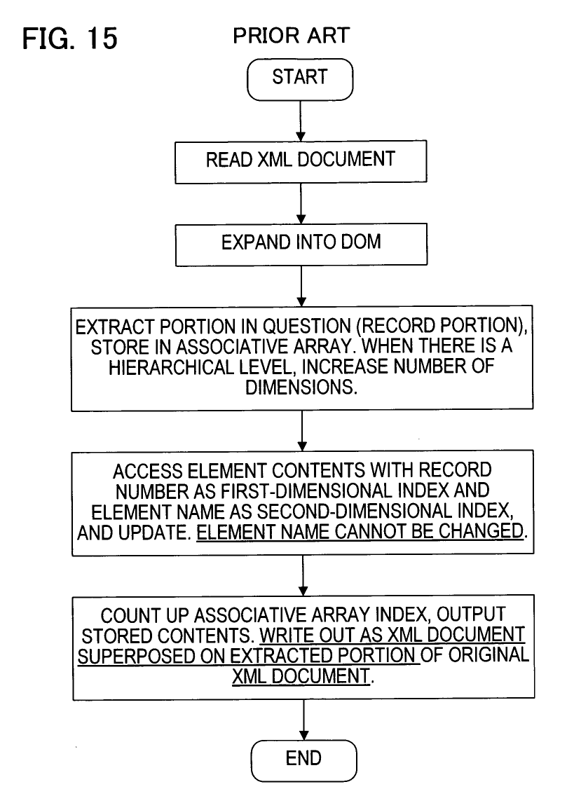

In FIG. 1, the “catalog” record in the XML document of FIG. 10 is expanded. In FIG. 1, associative arrays Tag1 of tags with one-dimensional indices are assigned to the element names “model name” and “part” in the first level in FIG. 10. Here, the two indices “20” and “30” are assigned to “part(1)” to distinguish between the attribute associative array (here, with @type “CPU”), and the element content associative array Array[“30”].

For the element names “name”, “model number” and similar in the second level in FIG. 10, tag associative arrays Tag2 with two-dimensional indices are assigned. For example, Tag2=1 is assigned to the element name “name”, and this Tag2 specifies the first element contents (CPU kit) of the element contents associative array Array[30]; similarly below.

On the other hand, the application program makes specifications using the two-dimensional associative array Array[Tag1 [“record element name”]][Tag2 [“element name/attribute name containing path”]], as shown in FIG. 2. Tag1 and Tag2 are one-dimensional tag associative arrays which use indices in Array; the one-dimensional array Tag1, which stores element names, is used to access the associative array storing element contents, and these provide the actual storage position.

As shown in FIG. 1, the associative array Tag1 representing the outside of a specified record element is written with sequence numbers assigned in steps of 10. Here, 10, 20, 30, 40, . . . are used.

By using sequence numbers in steps of 10, it is possible to insert ten record elements in between. Upon deletion, only the record element in question disappears, and the order of the number sequence does not change. An associative array merely associates the character strings which are the indices with the corresponding storage locations, and so even if numbers in sequence are employed, memory corresponding to the intervals between the assigned numbers is not used.

To be precise, in a table format, the parts catalog illustrated in the XML document of FIG. 10 has different elements in the records for each “part”. In this table format, as indicated in FIG. 1, even if sequence numbers are assigned to elements (element names) in a record, in an associative array only the area of a one-to-one correspondence relation between indices and stored contents is stored in memory. Hence the areas of elements which do not appear in a record are not included as in a table format, and each record uses only the net area in memory.

Further, if as explained below the tag associative arrays Tag1, Tag2 are replaced with different element name arrays, element names can be modified.

FIG. 3 explains an embodiment in which the associative array method of this invention is deployed in an API processor. The API processor (API software) 10 to which an associative array method of this invention is applied comprises the XML processor SAX 30, and an application software 20 which uses an associative array method of this invention.

In FIG. 3, the input XML document is divided into serial events (start tags, element contents, end tags, attribute names, attribute values, and similar) by SAX 30, and these are passed to the application software 20. In the application software 20, as explained in FIG. 1 and FIG. 2, the passed event series is stored in tag associative arrays and content associative arrays.

For example, in the example of FIG. 3, “title” and “p” are element names, the index tag associative array Tag is Tag2 in FIG. 1 and FIG. 2, and “notification of physical checkup” and “tomorrow's company medical examinations” are element contents, stored in the associative array Array storing the data of FIG. 1 and FIG. 2. Tag2 is created as the contents of the associative array to address by counting-up the tag counter Tag-count. Here there is a single record “memo”, so that Tag1 is not displayed.

Structured Document Expansion Method

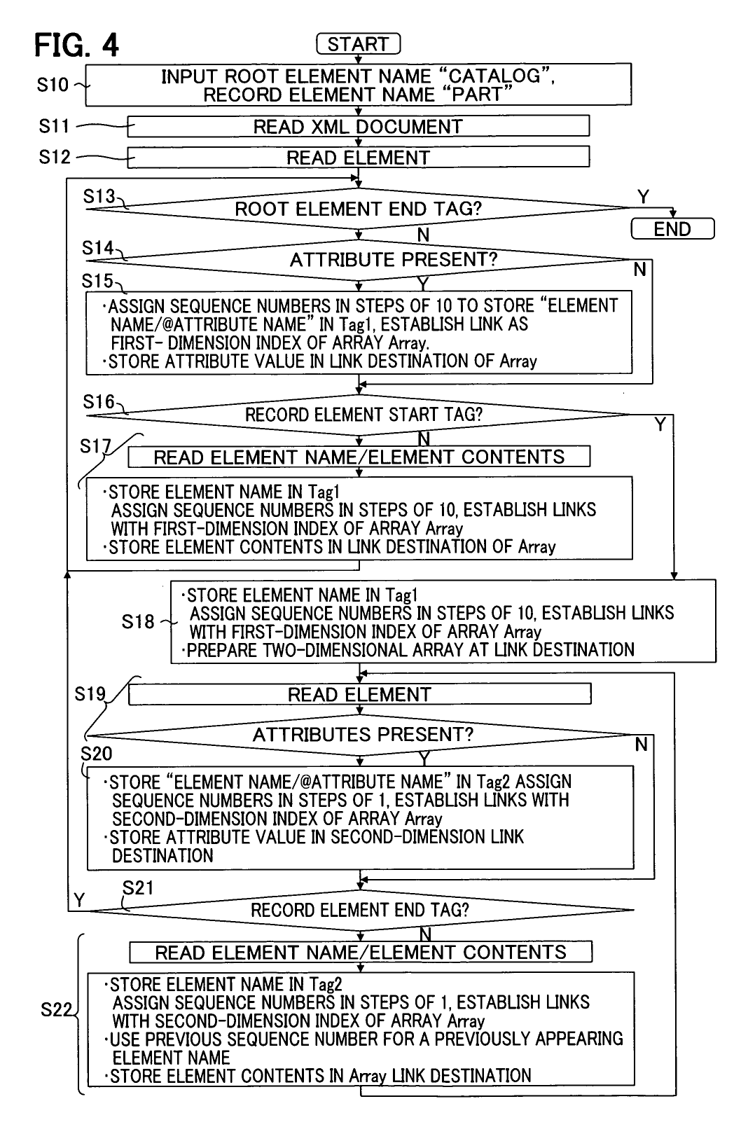

FIG. 4 is a diagram of the flow of processing to read an XML document and store the document in associative arrays in an embodiment of the invention. Here the associative arrays “Tag1” and “Tag2” which store tags, and the associative array “Array” which stores element contents/attribute values, are used. The processing of FIG. 4 is explained referring to FIG. 1 and FIG. 10.

(S10) First, the XML document root element “catalog” and the element name “part” handled as a record element are input.

(S11) Then, the input XML document record (the catalog record of FIG. 10) is read.

(S12) The XML document record elements are read and analyzed.

(S13) An element is read, and a judgment is made as to whether the read element is the end tag of the root element (in FIG. 10, “</catalog>”). If the element is the root end tag, processing ends.

(S14) If the element is the root element but not the end tag of the root element, a judgment is made as to whether the root element has an attribute. If there is no attribute, processing proceeds to step S16.

(S15) If the element has an attribute, then as shown in FIG. 1, “element name/@attribute name” is stored in the tag associative array Tag1, and sequence numbers are assigned in steps of 10, and a link is established as the first-dimension index of the Array array. The attribute value is stored in the link destination in Array.

(S16) Next, a judgment is made as to whether the read element is a record element start tag. If judged to be a start tag, the record is the specified record, and so processing proceeds to step S18.

(S17) If the element is judged not to be a record element start tag, the element is outside the specified record, and so the element name/element contents outside the specified record is read, and the element name is stored in the tag name associative array Tag1 with a sequence number assigned in steps of 10, and a link is established as the first-dimension index to the Array array. Also, the element contents (in FIG. 1, “MS360”, “CPU”, or similar) are stored in the link destination in Array. Then processing returns to step S13.

(S18) If on the other hand the element is judged to be a record element start tag, the record is the specified record, and so the element name is stored in the tag name associative array Tag1, a sequence number is assigned in steps of 10, and a link is established as the first-dimension index of the Array array. For example, in FIG. 1 the parts are read and are stored as “part(1)”, “part(2)”, . . . . Further, a two-dimensional array is provided at the Array link destination.

(S19) An element is then read, and a judgment made as to whether the element is an attribute. If not an attribute, processing proceeds to step S21.

(S20) If the element is an attribute, “element name/@attribute name” is stored in the tag associative array Tag2, a sequence number is assigned in steps of 1, and a link is established as the second-dimension index of the Array array. Further, the attribute value (in FIG. 1, “MS360”, “CPU”) is stored in the link destination in Array.

(S21) A judgment is made as to whether the element is a record element end tag. If a record element end tag, processing returns to step S13.

(S22) On the other hand, if the element is not a record element end tag, then the element name/element contents are read, the element name is stored in the tag name associative array Tag2, a sequence number is assigned in steps of 1, and a link is established as the second-dimension index of the Array array. At this time, an element name which has already appeared uses the previous sequence number. Further, the element contents (in FIG. 1, “MS360”, “CPU”) are stored at the link destination in Array. Processing then returns to step S19.

In this way, when an element is a record element start tag, an index “(i)” is assigned to the record element name, and a sequence number assigned in steps of 10 as the index of the tag name associative array Tag1 is stored in an array. The next element to appear is regarded as being within the record, and the element name is taken to be the index of the tag name associative array Tag2, and a sequence number in steps of 1 is stored in the array. Then an element is read, and until the record element end tag appears the read-out element name/attribute name is used as an index, and a sequence number is assigned and stored in the tag array Tag2.

If the element name/attribute name has already appeared, the previously assigned sequence number is used. The element contents/attribute value which has appeared is then stored in the contents associative array Array, with the record sequence number as the first-dimension index, and the assigned sequence number as the second-dimension index. When a record element end tag appears, the next element is checked to determine whether the element is the root element end tag. If the root element end tag appears, processing ends.

Thus the contents of a two-dimensional associative array Array can be accessed using element names/attribute names in an XML document, with reading from and writing to the array. The associative array stores all the elements and attributes in the XML document, and after update processing, the result can be written out to an XML document.

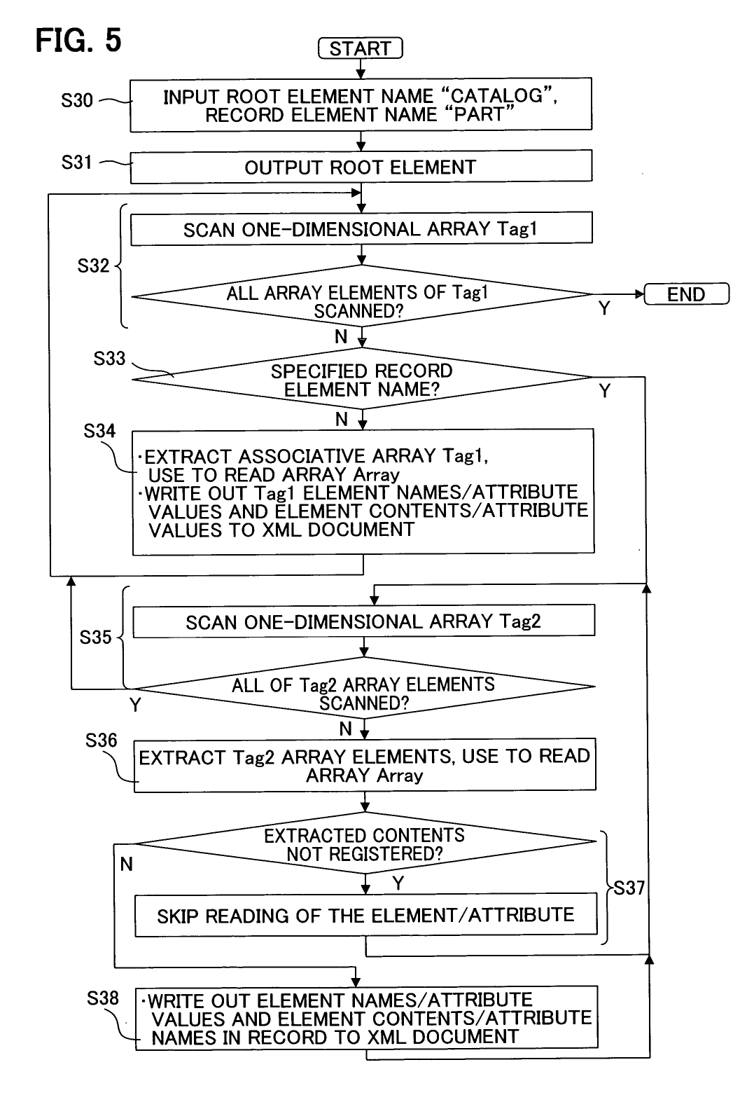

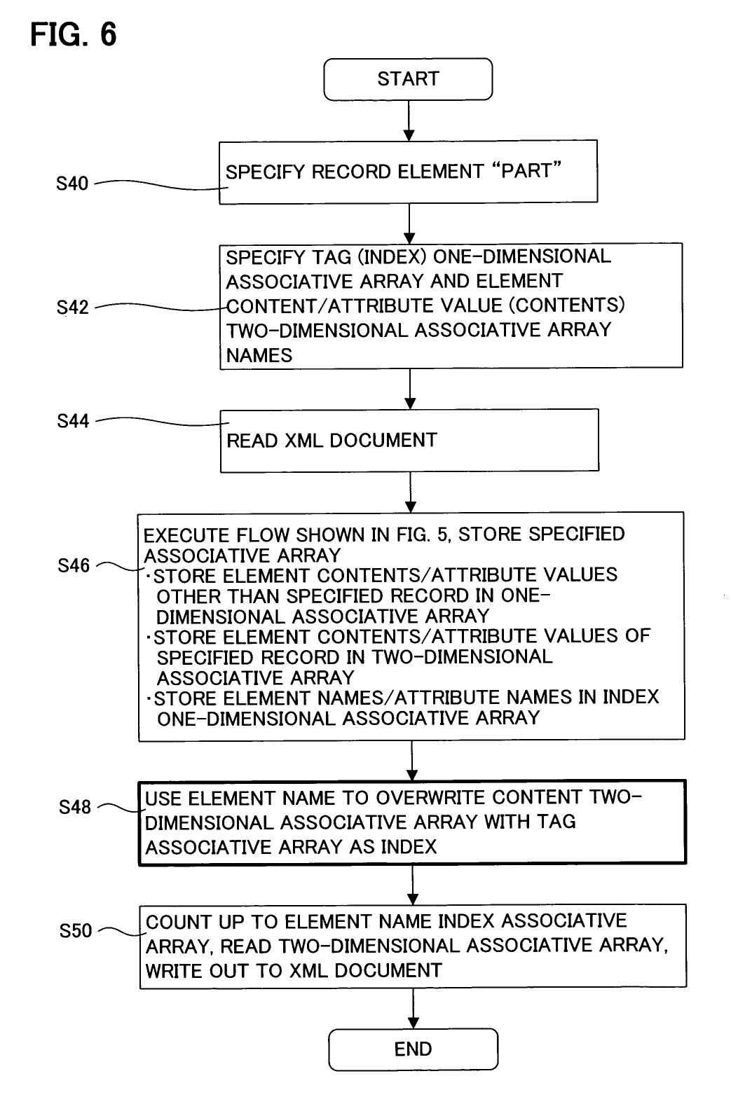

Next, XML document output processing (write processing) is explained. FIG. 5 is a diagram of the flow of XML document output in an embodiment of the invention. Here, tag associative arrays storing tags “Tag1” and “Tag2”, and the associative array “Array” storing element contents/attribute values, are used. The processing of FIG. 5 is explained referring to FIG. 1 and FIG. 10.

(S30) First, the XML document root element “catalog” and the element name “part” to be handled as a record element are input (specified).

(S31) The input root element is output.

(S32) The stored-content one-dimensional arrays Tag1 of FIG. 1 are scanned in order. A judgment is made as to whether all the array elements of the one-dimensional array Tag1 have been scanned. If all have been scanned, processing ends.

(S33) If all have not been scanned, a judgment has made as to whether a scanned element has the specified record element name specified in step S30. If the name is the specified record element name, processing proceeds to step S35.

(S34) If on the other hand the name is not the specified record element name, the array element of the tag array Tag1 is extracted, and the Array array is read. The Tag1 element name/attribute name and element contents/attribute value are then written out to the XML document. Processing then returns to step S32, and the next Tag1 is scanned.

(S35) When the name is the specified record element name, the stored-content one-dimensional arrays Tag2 of FIG. 1 are scanned in order. A judgment is made as to whether all the array elements of the one-dimensional arrays Tag2 have been scanned. If all scanning has been performed, processing returns to step S32.

(S36) If not all elements have been scanned, the array elements of the scanned tag arrays Tag2 are extracted, and the Array array is read.

(S37) A judgment is made as to whether the extracted contents have been registered (exist in the Array array derived from the array element of the tag arrays Tag2). If not registered, reading of the Tag2 element/attribute is skipped, and processing returns to step S35. For example, when “200 GB”, which is the content of “capacity” for “7” in Tag2 in FIG. 1 is not registered in one Array[“50”] derived from the array element of the tag arrays Tag2, reading is skipped.

(S38) If on the other hand the extracted content has been registered, the Tag2 element name/attribute value and element content/attribute value are written out to the XML document. That is, the XML document is written out as text of variable length. However, in order to facilitate access in memory, the document is stored in a fixed-length format. Processing then returns to step S35, and the next Tag2 is scanned.

In this way, an associative array of this invention stores all of the elements and attributes of the XML document, so that after update processing the result can be written out as an XML document.

Structured Document Processing Using Structured Document Expansion Processing as an API

FIG. 6 is a diagram of the flow of processing of a structured document with structured document expansion processing as an API, in one embodiment of the invention.

(S40) First, a record element to be processed (in the example of FIG. 1, “part”) is specified.

(S42) As shown in FIG. 2, the name of a one-dimensional associative array Tag1 of the tag (index) for processing, and the names of the two-dimensional associative array of element contents/attribute values (contents) (Tag1, Tag2, Array), are specified.

(S44) The XML document is read.

(S46) The processing shown in FIG. 5 is executed, with storage in the specified associative array, as shown in FIG. 1. That is, element contents/attribute values other than for the specified record are stored in a one-dimensional associative array, and the element contents/attribute values of the specified record are stored in the two-dimensional associative array (second stage) Array. The element name/attribute name of the specified record is stored as an index in a one-dimensional associative array Tag2.

(S48) Using the element name, the element contents two-dimensional array Array is overwritten with the tag associative array Tag2 as an index.

(S50) The number of element name index associative arrays is counted, the two-dimensional associative array Array is read, and the XML document is written out. Processing then ends.

Using element names/attribute names of an associative array in this way, array contents can be accessed to read from and write to the array. This associative array stores all the elements and attributes of an XML document, and after update processing, the result can be written out to an XML document.

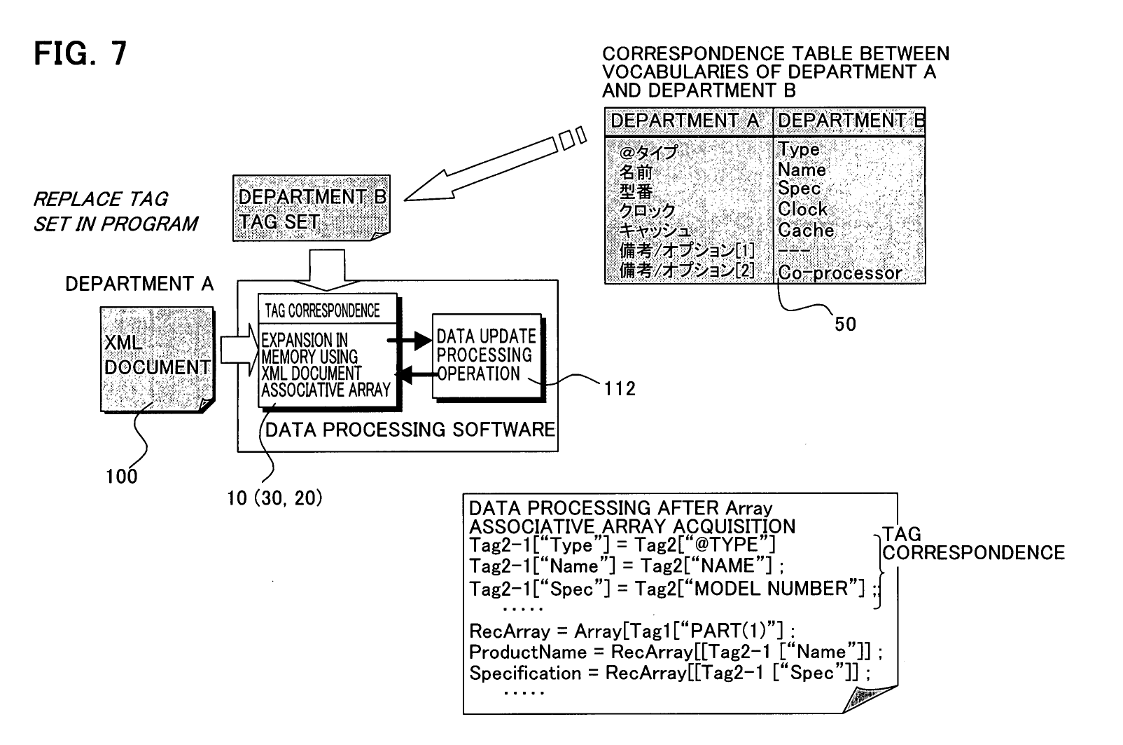

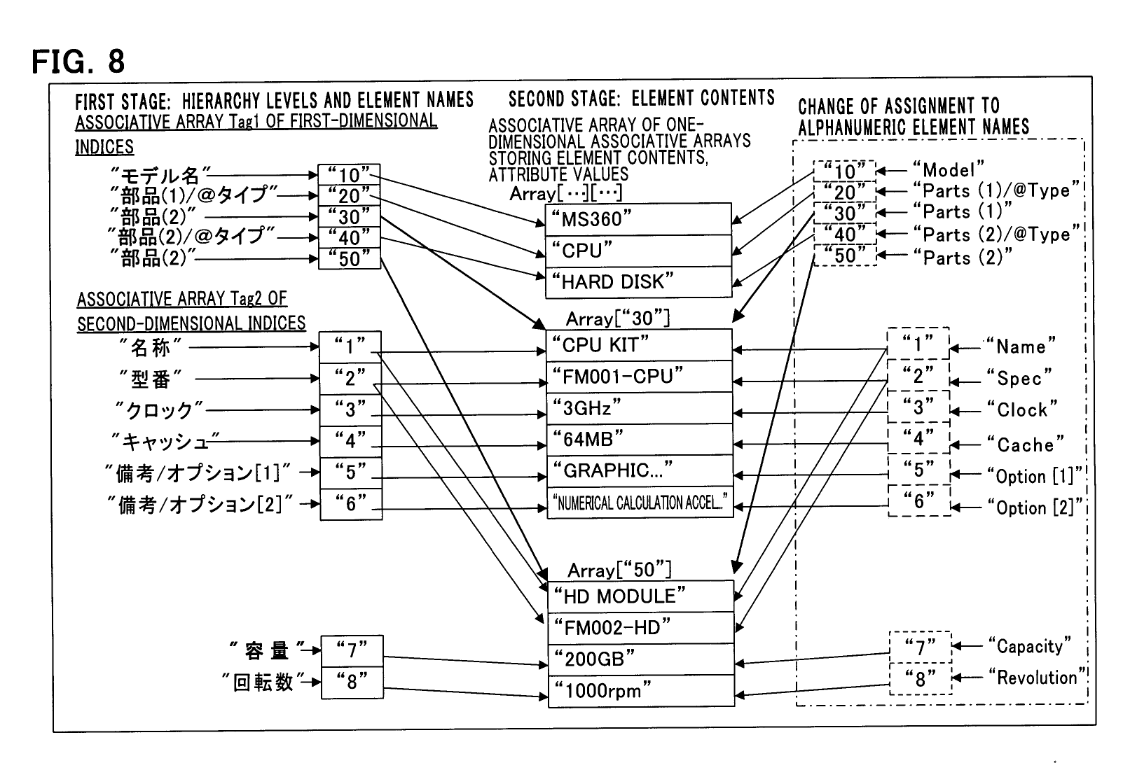

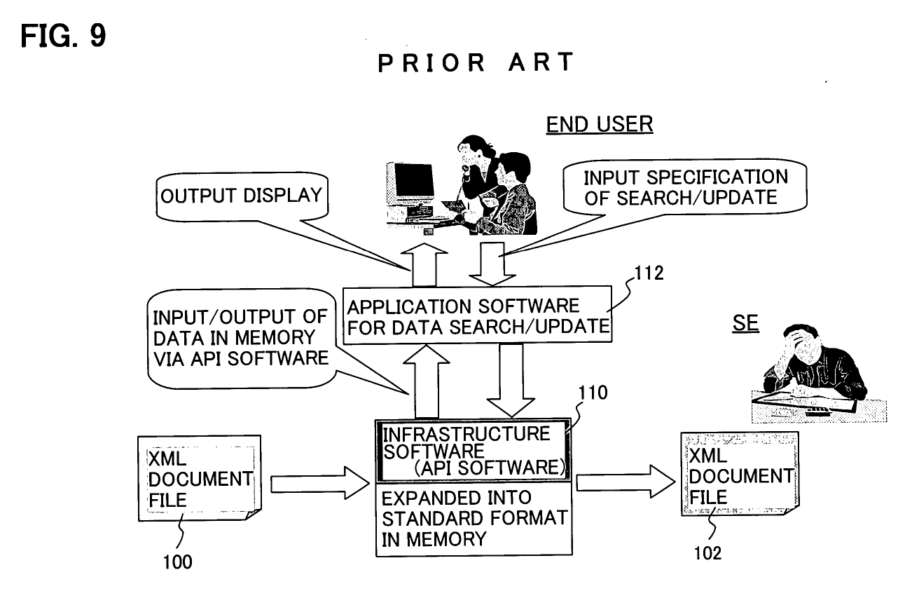

FIG. 7 and FIG. 8 explain structured document processing with structured document expansion processing as an API, in another embodiment of the invention. FIG. 7 shows an application to data processing of an XML document, when different tag sets are being used by one department (for example Department A) and another department (for example Department B).

First, a vocabulary correspondence table 50 for Department A and Department B is prepared by Department B. The correspondence table uses tag sets in Japanese language and in English language. Using this correspondence table, tags are associated. As shown in FIG. 8, the XML document 100 of Department A is expanded into tag associative arrays Tag1, Tag2 and an element content/attribute value associative array Array, similar to those in FIG. 1, through the associative array processing of FIG. 5.

In the correspondence table of FIG. 7, as shown in FIG. 8, by using associative arrays with different indices (alphanumeric element names) Tag1-1 and Tag2-1, data processing can be performed using different names. That is, the XML document 100 is read, and after using the associative array 10 to expand the document in memory, the tags of Department A and Department B are associated, as indicated by the tag association of FIG. 7. As indicated in FIG. 8, the contents of a tag array Tag2 of Department A are moved to the tag array Tag2-1 of Department B. By this means, data update processing software 112 can use the tags of Department B to access the element contents of Department A.

Thus in the prior art, simply because different tags are used, two copies of an XML document would have to be created for use by Department A and for use by Department B, and data processing software would also have to be used separately in the respective departments. In order to avoid such difficulties, after setting in advance and in top-down manner an XML document tag set, it had been necessary to use a common tag set and data processing software in both the departments. However, in such a method it is not possible to convert data into XML until the common tag set is finalized in a top-down manner. Also, in this example tag sets are in Japanese language and English language; if Department A is in Japan and Department B is overseas, usage by each department is easier if two systems are used, without employing common tags.

By means of this invention, it is not necessary to adopt a common tag set in a top-down manner as in the prior art; if the overall items are in agreement, conversion into XML can be begun in a bottom-up manner, and differences between tag sets can be absorbed merely through tag set associations. Further, it is possible to use tag sets in parallel, as in the case of the Japanese language and English language tag sets of this example.

Thus whereas in the prior art a portion of an XML document has been stored in an associative array, according to this invention an entire XML document is stored in a two-dimensional associative array which can be used as an API, so that through intuitive array operations alone, various data operations can easily be performed spanning the entire XML document.

Because record element names are provided and a two-dimensional array structure which reflects array elements is used, the record interior and exterior can be distinguished, and handling of data as objects in record units is possible. Further, through an API format of this invention, merely by changing the former-stage associative array, different element names can be used to easily access element contents. Modification of levels and element names within records, and record insertion, deletion, and other operations, can also be performed.

### Other Embodiments

In the above-described embodiments, an XML document was explained as an example of a structured document; but application to other structured documents is also possible. Moreover, in the explanation an expanded XML document as in the example of FIG. 10, and as shown in FIG. 1 and FIG. 2, was used; but application to XML documents with other contents is also possible. Further, in place of the SAX of FIG. 3, DOM can also be used.

In the above, embodiments of the invention have been explained, but various modifications are possible within the scope of the invention, and these modifications are not excluded from the scope of the invention.

Because an entire structured document can be stored in a two-dimensional associative array and used as an API, various data operations can be performed spanning the entire structured document using only intuitive array operations. A two-stage associative array structure is adopted, and by using sequence numbers to link associative arrays, an element name from a former-stage associative array can be used to access the latter-stage associative array, and the latter stage employs a two-dimensional associative array to represent levels, contributing to development of structured document applications.

What is claimed is:

1. A structured document expansion method of dividing into elements a structured document comprised of records and expanding said structured document into memory, comprising the steps of:
assigning said elements with an element name/attribute name including a path as an index and with a sequence number associated with the order of appearance assigned to the contents and storing in a first-stage associative; and
storing element contents/attribute values corresponding to the contents in a second-stage associative array, with said sequence numbers as an index.

2. The structured document expansion method according to claim 1, wherein said step of assigning a sequence number and storing comprises:
a step of assigning a first sequence number as a first-dimension index and storing the higher hierarchical level of said record element; and
a step of assigning a second sequence number as a second-dimension index and storing the hierarchical level within said record element.

3. The structured document expansion method according to claim 2, wherein said step of assigning a first sequence number and storing comprises a step, when representing a hierarchical level outside a specified record, of assigning said first sequence number with an interval provided.

4. The structured document expansion method according to claim 1, wherein said structured document comprises an XML document.

5. The structured document expansion method according to claim 4, further comprising a step of reading said XML document, converting element start tags, element contents, and element end tags into event type output, and inputting said converted events as said elements.

6. The structured document expansion method according to claim 4, wherein
said step of assigning sequence numbers and storing comprises:
a step of detecting the start tag of a record element of said XML document;
a step, upon detecting said start tag, of assigning a first sequence number and storing the element name of said record element; and
a step of assigning a second sequence number and storing the element name of said record element in succession to the record element of said start tag;
and wherein said step of storing element contents/attribute values comprises a step of storing the element contents of said record element at a position corresponding to said second sequence number.

7. The structured document expansion method according to claim 6, wherein said step of assigning a first sequence number and storing comprises a step, when representing a hierarchical level outside a specified record, of assigning said first sequence number with an interval provided.

8. The structured document expansion method according to claim 4, wherein
said step of assigning a sequence number and storing comprises:
a step of detecting the start tag of the higher hierarchical level of a record element of said XML document;
a step, upon detecting said start tag, of assigning a first sequence number and storing the element name of said record element;
a step of setting a two-dimensional array as the link destination of said first sequence number;
a step of detecting a start tag within said record element; and
a step, upon detection of a start tag within said record element, of assigning a second sequence number and storing the element name of said record element;
and wherein said step of storing element contents/attribute values comprises a step of storing the element contents of said record element at the position corresponding to said second sequence number within said set two-dimensional array.

9. The structured document expansion method according to claim 2, further comprising:
a step of scanning a specified record element to which said first sequence number has been assigned to retrieve said first sequence number of the specified record element; and
a step of scanning the element contents within the record element to which said second sequence number corresponding to the two-dimensional array of said first sequence number is assigned, and of extracting element contents in said two-dimensional array.

10. A structured document processing method of dividing into elements a structured document comprising records, expanding said structured document into memory, and processing the expanded records, comprising the steps of:
assigning said elements with an element name/attribute name including a path as an index and with a sequence number associated with the order of appearance assigned to the contents and storing in a first-stage associative array;
storing element contents/attribute values corresponding to the contents in a second-stage associative array, with said sequence numbers as an index;
processing said element contents/attribute values of a record specified by said element name/attribute name including the path by using said sequence numbers; and
reading said element contents/attribute values using said sequence numbers, and writing out to said structured document.

11. The structured document processing method according to claim 10, wherein said step of assigning a sequence number and storing comprises:
a step of assigning a first sequence number as a first-dimension index and storing the higher hierarchical level of said record element; and
a step of assigning a second sequence number as a second-dimension index and storing the hierarchical level within said record element.

12. The structured document processing method according to claim 11, wherein said step of assigning a first sequence number and storing comprises a step, when representing a hierarchical level outside a specified record, of assigning said first sequence number with an interval provided.

13. The structured document processing method according to claim 10, wherein said structured document comprises an XML document.

14. The structured document processing method according to claim 13, further comprising a step of reading said XML document, converting element start tags, element contents, and element end tags into event type output, and inputting said converted events as said elements.

15. The structured document processing method according to claim 13, wherein
said step of assigning sequence numbers and storing comprises:
a step of detecting the start tag of a record element of said XML document;
a step, upon detecting said start tag, of assigning a first sequence number and storing the element name of said record element; and
a step of assigning a second sequence number and storing the element name of said record element in succession to the record element of said start tag,
and wherein said step of storing element contents/attribute values comprises a step of storing the element contents of said record element at a position corresponding to said second sequence number.

16. The structured document processing method according to claim 15, wherein said step of assigning a first sequence number and storing comprises a step, when representing a hierarchical level outside a specified record, of assigning said first sequence number with an interval provided.

17. The structured document processing method according to claim 13, wherein
said step of assigning a sequence number and storing comprises:
a step of detecting the start tag of the higher hierarchical level of a record element of said XML document;
a step, upon detecting said start tag, of assigning a first sequence number and storing the element name of said record element;
a step of setting a two-dimensional array as the link destination of said first sequence number;
a step of detecting a start tag within said record element; and
a step, upon detection of a start tag within said record element, of assigning a second sequence number and storing the element name of said record element,
and wherein said step of storing element contents/attribute values comprises a step of storing the element contents of said record element at the position corresponding to said second sequence number within said set two-dimensional array.

18. The structured document processing method according to claim 11, further comprising:
a step of scanning a specified record element to which said first sequence number has been assigned to retrieve said first sequence number of the specified record element; and
a step of scanning the element contents within the record element to which said second sequence number corresponding to the two-dimensional array of said first sequence number is assigned, and of extracting element contents in said two-dimensional array.

19. The structured document processing method according to claim 11, wherein said processing step comprises a step of using said sequence numbers for transferring to an associative array having different element contents/attribute values.

20. The structured document processing method according to claim 19, wherein said processing step comprises:
a step of transferring to and associating with an associative array having a different set of tag names, which is said structured document; and
a step of processing the same XML document by using different vocabularies.
